(19) United States
(12) Patent Application Publication
(10) Pub. No.: US 2014/0047462 A1
(43) Pub. Date: Feb. 13, 2014

(54) SLIM TYPE OPTICAL DISC DRIVE

(71) Applicant: HITACHI-LG DATA STORAGE KOREA, INC., Seoul (KR)

(72) Inventor: Cheulkyung HAN, Seoul (KR)

(73) Assignee: HITACHI-LG DATA STORAGE KOREA, INC., Seoul (KR)

(21) Appl. No.: 13/949,682

(22) Filed: Jul. 24, 2013

(30) Foreign Application Priority Data
Aug. 7, 2012 (KR) 10-2012-0086054

(51) Int. Cl. G11B 17/053

(52) U.S. Cl. CPC G11B 17/053
USPC 720/601

(57) ABSTRACT

There is provided a slim type optical disc drive. The slim type optical disc drive includes a cabinet including an upper chasse and a lower chasse, a tray to be introduced to an inside of the cabinet or withdrawn to an outside of the cabinet, a sub-printed circuit board (PCB) provided in the tray, a main PCB provided on one side of an internal rear surface of the lower chasse, and a cable divided into a first part and a second part based on a line folded in a direction that does not run parallel with the wiring lines to electrically connect the main PCB and the sub-PCB. The second part connected to the sub-PCB does not run parallel with the first part connected to the main PCB in a state where the cable is folded but floats in accordance with a movement of the tray.

### BACKGROUND

1. Field

The present invention relates to a slim type optical disc drive, and more particularly, to a cable for connecting a main printed circuit board (PCB) and a sub-PCB of a tray in a slim type optical disc drive for introducing and withdrawing a disc through a tray.

2. Related Art

FIG. 1 illustrates a conventional slim type optical disc drive. A tray 20 is introduced to and withdrawn from a cabinet 10 consisting of a lower chasse 10a and an upper chasse 10b to be loaded in and unloaded from an optical disc drive.

A spindle motor 30 and an optical pick-up apparatus 40 are mounted in the tray 20. The optical pick-up apparatus 40 is provided in two guide shafts 50 fixed to the tray 20 in parallel and includes an object lens 41 and an actuator (not shown) for driving the object lens 41. Guide units 42 slided by the shafts 50 are provided on both sides of the optical pick-up apparatus 40.

A transfer motor 60 having a screw 61 is provided as a transfer apparatus for reciprocating the optical pick-up apparatus 40. Since the screw 61 is engaged with a screw combining unit 62 combined with the optical pick-up apparatus 40, the optical pick-up apparatus 40 reciprocates along the guide shafts 50 in accordance with a rotation of the screw 61.

As illustrated in FIG. 2, the tray 20 provides a space 22 in which the optical pick-up apparatus 40 may be provided to move, the shafts 50 are arranged in parallel on both sides of the space 22, and both ends of the shafts 50 are supported on posts 23 and 24 provided in the tray 20. The posts 23 and 24 may be integrated with the tray 20.

Both ends of the optical pick-up apparatus 40 are supported on the guide shafts 50 by the guide units 42. The screw combining unit 62 engaged with the screw 61 of the transfer motor 60 is provided on one side of the optical pick-up apparatus 40.

A motor base 21 that functions as a base of the spindle motor 30 is provided on one side of the space 22 of the tray 20. As illustrated in FIG. 3, a shaft supporting unit 35 having a bearing (not shown) for supporting a rotation shaft 33 of the spindle motor as a part of the tray 20 is fixed to the motor base 21.

In addition, a magnetic coil unit 34 that is a stator is fixed to an upper end of the shaft supporting unit 35 and permanent magnets 32 are provided in a rotor 31 on whose top surface an optical disc 1 is mounted.

A flexible flat cable (FFC) having a plurality of wiring lines is used for connecting a sub-printed circuit board (PCB) for driving the spindle motor 30, the optical pick-up apparatus 40, and the transfer motor 60 mounted in the tray and transmitting a signal read by the optical pick-up apparatus 40 from the optical disc and a main PCB provided in the lower chasse of the cabinet.

As illustrated in FIG. 4, the main PCB provided on an internal rear surface of the lower chasse the sub-PCB provided on a bottom surface of the tray to drive the spindle motor 30, the optical pick-up apparatus 40, and the transfer motor 60 may be electrically connected by a folded linear FFC.

Since the tray moves to inside and an outside of the cabinet, the linear FFC one end of which is connected to the sub-PCB provided in the tray must be longitudinally arranged in a vertical direction where the tray moves while being introduced and withdrawn.

In addition, as illustrated in FIG. 4, since the sub-PCB must be arranged around the rotation shaft of the spindle motor based on a horizontal direction that is perpendicular to the vertical direction in which the tray moves, the main PCB is longitudinally arranged in the horizontal direction to overlap the sub-PCB no less than a width of the FFC based on the horizontal direction. At this time, as illustrated in FIG. 4, a connector for connecting the main PCB to a host may be provided not in a center but in a corner on the internal rear surface of the lower chasse in consideration of an internal structure of the host for accommodating the slim type optical disc drive.

However, as illustrated in FIG. 5, when a size of the main PCB is reduced in order to reduce the number of parts and cost, unless the connector for connecting the main PCB to the host is moved to the center of the internal rear surface of the lower chasse, the main PCB and the sub-PCB may be separated from each other without being overlapped no less than the width of the FFC based on the horizontal direction.

In this case, as illustrated in FIG. 5, a complicatedly shaped FFC folded twice at an angle of 90° must be used. In this case, when the tray is repeatedly introduced and withdrawn in order to load and unload the optical disc, folded parts of the FFC may be damaged due to friction.

In addition, since the complicatedly shaped FFC is used, manufacturing cost is increased and productivity is deteriorated. Since the wiring lines overlap each other in the folded parts, a probability of generating electrical interference between signal lines is increased.

### SUMMARY

Accordingly, the present invention has been made in an effort to solve the above problems. It is an object of the present invention to provide a slim type optical disc drive capable of stably connecting two printed circuit boards (PCB) through a simply structured cable even when a PCB provided in a tray that repeatedly reciprocates and a PCB fixed to a cabinet are separated from each other in a direction perpendicular to a movement direction of the tray.

A slim type optical disc drive according to an exemplary embodiment of the present invention may include a cabinet including an upper chasse and a lower chasse, a tray including a spindle motor for rotating an optical disc, an optical pick-up for reading data from an optical disc or recording data in an optical disc, and a transfer motor for moving the optical pick-up to an internal circumference or an external circumference of the optical disc and to be introduced to an inside of the cabinet or withdrawn to an outside of the cabinet in order to load and unload the optical disc, a sub-printed circuit board (PCB) provided in the tray to drive at least one of the spindle motor, the optical pick-up, and the transfer motor, a main PCB provided on one side of an internal rear surface of the lower chasse to be separated from the sub PCB being based on a direction perpendicular to a direction in which the tray moves, and a cable having a plurality of wiring lines and divided into a first part and a second part based on a line folded in a direction that does not run parallel with the wiring lines to electrically connect the main PCB and the sub-PCB. The second part connected to the sub-PCB does not run parallel with the first part connected to the main PCB in a state where the cable is folded but floats in accordance with a movement of the tray.

In an embodiment, an end of the first part may be connected to the main PCB by soldering or a connector.

In an embodiment, an end of the first part may be fixed to the main PCB to be tilted at a predetermined angle from a rear surface of the lower chasse.

In an embodiment, the predetermined angle is the same as an angle formed by the first part and the second part in a state where the cable is folded.

In an embodiment, the predetermined angle may be set in proportion to a distance by which the main PCB and the sub PCB are separated from each other based on a direction perpendicular to a direction in which the tray moves.

In an embodiment, in the main PCB, a fixing sheet for fixing the end of the first part to the main PCB may be attached to an opposite surface to a surface connected to the end of the first part.

In an embodiment, a mark that indicates a position to which the fixing sheet may be to be attached is displayed on the opposite surface.

In an embodiment, an end of the second part may be fixed by a connector provided in the sub-PCB.

In an embodiment, the connector may be arranged to be perpendicular to the direction in which the tray moves.

In an embodiment, the entire first part or a part of the first part may be fixed to the lower chasse by the fixing sheet.

In an embodiment, a part in which the first part and the second part overlap each other may be fixed to the lower chasse by the fixing sheet.

In an embodiment, the second part moves in accordance with the movement of the tray in a state where a part of the second part is bent.

Therefore, although the tray repeatedly moves for a long time, it is possible to prevent the cable from being damaged. In addition, manufacturing cost may be reduced and productivity may be improved by using the simply structured cable and the folded parts of the wiring lines may be minimized so that a probability of generating electrical interference between signal lines may be reduced.

### BRIEF DESCRIPTION OF THE DRAWINGS

FIG. 1 illustrates a conventional slim type optical disc drive;

FIG. 2 illustrates a tray of a conventional slim type optical disc drive;

FIG. 3 illustrates a section of a spindle motor of a conventional slim type optical disc drive;

FIGS. 4 and 5 illustrate a flexible flat cable (FFC) for connecting a main printed circuit board (PCB) and a sub-PCB in a conventional slim type optical disc drive;

FIG. 6 illustrates a folded shape of the FFC used for a slim type optical disc drive according to an exemplary embodiment of the present invention; and

FIGS. 7 and 8 illustrate an exemplary embodiment in which a folded FFC is used for a slim type optical disc drive like in FIG. 6.

### DETAILED DESCRIPTION OF THE INVENTION

Hereinafter, exemplary embodiments of a slim type optical disc drive according to the present invention will be described in detail with reference to the attached drawings.

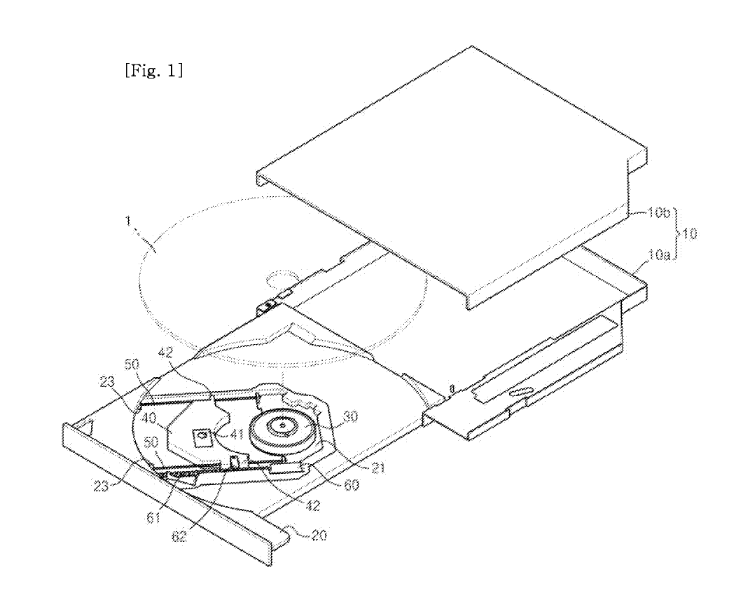

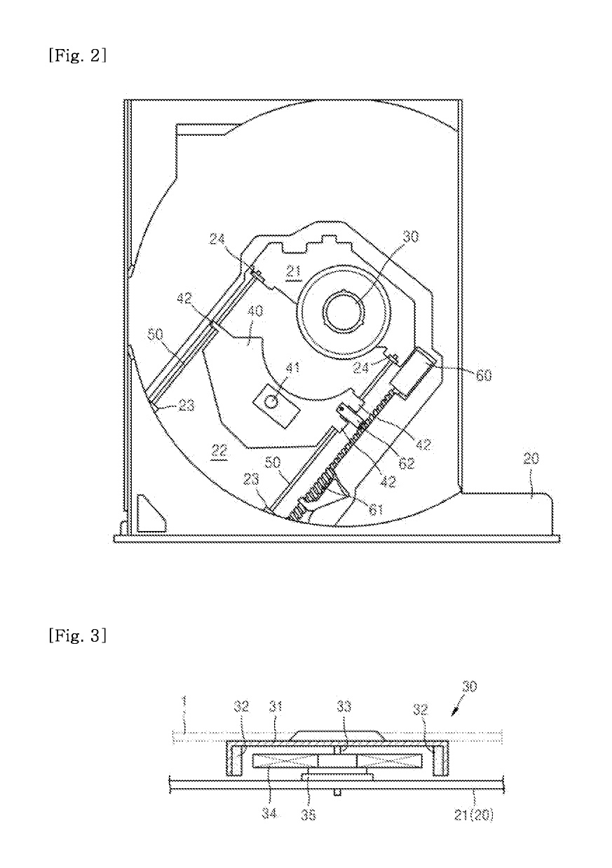

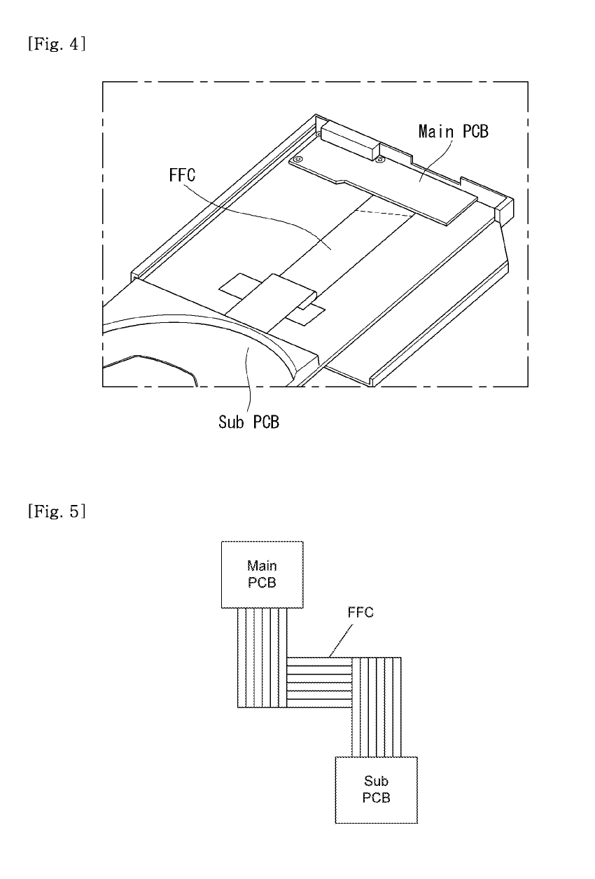

As described above with reference to FIG. 1, a slim type optical disc drive according to the present invention includes a cabinet 10 consisting of a lower chasse 10a and an upper chasse 10b and a tray 20 inserted into or ejected from the cabinet. A spindle motor for rotating an optical disc at a high speed, an optical pick-up for reading data from the optical disc or recording data in the optical disc, and a transfer motor for moving the optical pick-up to an internal circumference and an external circumference of the optical disc may be provided in the tray.

In addition, a sub-printed circuit board (PCB) for driving the spindle motor, the optical pick-up, and/or the transfer motor is provided in the tray and a main PCB is provided on one side of an internal rear surface of the lower chasse 10a of the cabinet. As described above with reference to FIG. 5, the main PCB and the sub-PCB may be separated from each other without being overlapped based on a horizontal direction.

According to the present invention, in order to electrically connect the main PCB and the sub-PCB, a simply structured flexible flat cable (FFC) is used as a cable having a plurality of wiring lines.

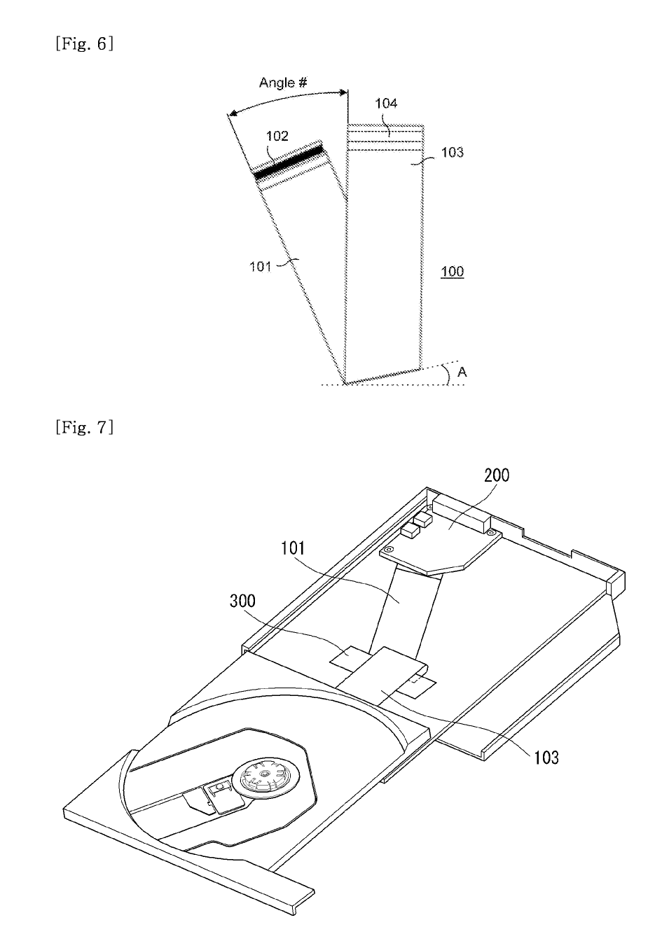

As illustrated in FIG. 6, a linear FFC 100 is divided into a first part 101 and a second part 103 based on a line folded in a direction that does not run parallel with wiring lines for connecting both ends of the FFC. The linear FFC 100 is folded so that the lower first part 101 close to a first connection unit 102 connected to the main PCB and the upper second part 103 close to a second connection unit 104 connected to the sub-PCB do not run parallel with each other, that is, the folded line is not perpendicular to a direction in which the wiring lines proceed and the same wiring lines of the first part 101 and the second part 103 form a predetermined angle A.

At an end of the first part 101, the first connection unit 102 connected to the main PCB is formed. At an end of the second part 103, the second connection unit 104 connected to the sub-PCB is formed.

The predetermined angle A may be set in proportion to a distance by which the main PCB and the sub-PPCB are separated from each other based on a horizontal direction perpendicular to a vertical direction in which the tray moves. Therefore, as the distance by which the main PCB and the sub-PCB are separated from each other based on the horizontal direction is larger, an angle at which the first part 101 and the second part 103 of the FFC are twisted is larger.

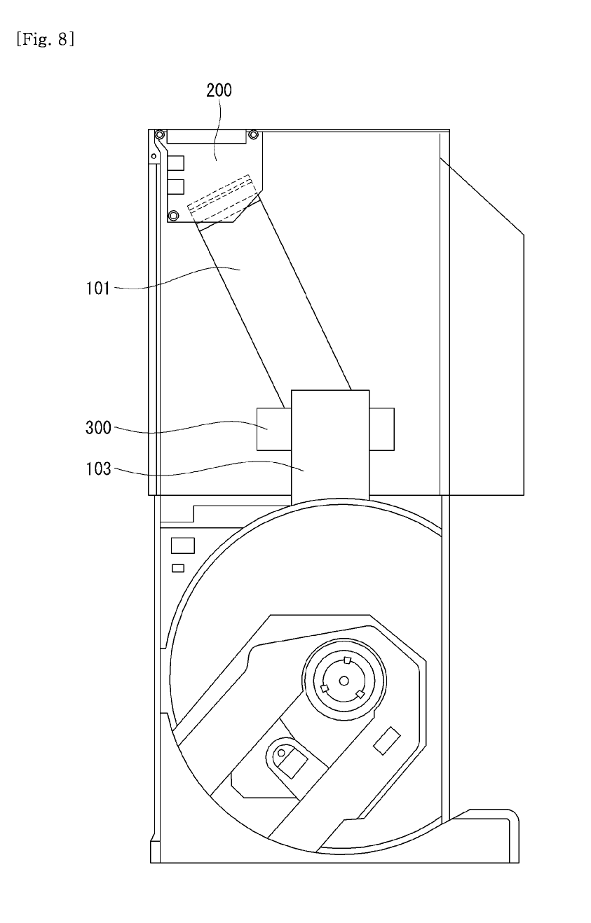

As illustrated in FIG. 8, a connection unit (not shown) formed in the main PCB 200 to be connected to the first connection unit 102 formed at the end of the first part 101 must be tilted at the predetermined angle based on the rear surface of the lower chasse so that the second part 103 of the FFC runs parallel with the vertical direction in which the tray moves when the first connection unit 102 of the FFC is fixed to the connection unit of the main PCB by soldering or a connector.

A connection unit (not shown) formed in the sub-PCB to be connected to the second connection unit 104 formed at the end of the second part 103 may be formed in a direction perpendicular to the vertical direction in which the tray moves without an additional tilt angle. The second connection unit 104 of the second part 103 may be fixed to the connection unit of the sub-PCB by soldering or the connector provided in the sub-PCB.

As illustrated in FIG. 8, the entire first part 101, a part of the first part 101, or a part in which the first part 101 and the second part 103 overlap each other is fixed to a bottom of the lower chasse by a fixing sheet 300 having an adhesive force, for example, an insulating adhesive tape so that the first part 101 of the FFC may be stably fixed although the tray repeatedly performs insertion and ejection, the second connection unit 104 formed at the end of the second part 103 of the FFC may be fixed to the connection unit of the sub-PCB provided in the tray, and the second part 103 of the FFC may float with the movement of the tray in a state where a part of the second part 103 of the FFC is bent.

In order to be connected to the first connection unit 102 formed at the end of the first part 101 of the FFC, on one surface of the main PCB 200, the connection unit may be formed at a predetermined tilt angle based on the rear surface of the lower chasse (or based on a direction in which the connector to be connected to the host is placed). In the main PCB 200, on an opposite surface to a surface where elements are provided, that is, a surface connected to the first connection unit 102, a mark that indicates a position to which the fixing sheet (for example, the adhesive tape) having the adhesive force is attached may be previously displayed so that the first part 101 of the FFC may be firmly fixed. In addition, the adhesive tape may be attached to the opposite surface to the surface where the elements are provided, that is, the surface connected to the first connection unit 102.

Therefore, according to the present invention, although the main PCB provided in the lower chasse of the cabinet is down-sized to be separated from the sub-PCB provided in the tray by the predetermined distance based on the horizontal direction perpendicular to the vertical direction in which the tray moves, the cable for electrically connecting the main PCB and the sub-PCB may be folded at an angle that is not perpendicular to the wiring lines so that manufacturing cost may be reduced and productivity may be improved.

In the above, the FFC is used for electrically connecting the main PCB and the sub-PCB. However, the present invention is not limited to the above but a flexible printed circuit (FPC) may be used instead of the FFC.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A slim type optical disc drive, comprising:
a cabinet including an upper chasse and a lower chasse;
a tray including a spindle motor for rotating an optical disc, an optical pick-up for reading data from an optical disc or recording data in an optical disc, and a transfer motor for moving the optical pick-up to an internal circumference or an external circumference of the optical disc and to be introduced to an inside of the cabinet or withdrawn to an outside of the cabinet in order to load and unload the optical disc;
a sub-printed circuit board (PCB) provided in the tray to drive at least one of the spindle motor, the optical pick-up, and the transfer motor;
a main PCB provided on one side of an internal rear surface of the lower chasse to be separated from the sub PCB being based on a direction perpendicular to a direction in which the tray moves; and
a cable having a plurality of wiring lines and divided into a first part and a second part based on a line folded in a direction that does not run parallel with the wiring lines to electrically connect the main PCB and the sub-PCB,
wherein the second part connected to the sub-PCB does not run parallel with the first part connected to the main PCB in a state where the cable is folded but floats in accordance with a movement of the tray.

2. The slim type optical disc drive of claim 1, wherein an end of the first part is connected to the main PCB by soldering or a connector.

3. The slim type optical disc drive of claim 2, wherein the end of the first part is fixed to the main PCB to be tilted at a predetermined angle from a rear surface of the lower chasse.

4. The slim type optical disc drive of claim 3, wherein the predetermined angle is the same as an angle formed by the first part and the second part in a state where the cable is folded.

5. The slim type optical disc drive of claim 3, wherein the predetermined angle is set in proportion to a distance by which the main PCB and the sub PCB are separated from each other based on a direction perpendicular to a direction in which the tray moves.

6. The slim type optical disc drive of claim 2, wherein, in the main PCB, a fixing sheet for fixing the end of the first part to the main PCB is attached to an opposite surface to a surface connected to the end of the first part.

7. The slim type optical disc drive of claim 6, wherein a mark that indicates a position to which the fixing sheet is to be attached is displayed on the opposite surface.

8. The slim type optical disc drive of claim 1, wherein an end of the second part is fixed by a connector provided in the sub-PCB.

9. The slim type optical disc drive of claim 8, wherein the connector is arranged to be perpendicular to the direction in which the tray moves.

10. The slim type optical disc drive of claim 1, wherein the entire first part or a part of the first part is fixed to the lower chasse by the fixing sheet.

11. The slim type optical disc drive of claim 10, wherein a part in which the first part and the second part overlap each other is fixed to the lower chasse by the fixing sheet.

12. The slim type optical disc drive of claim 10, wherein the second part moves in accordance with the movement of the tray in a state where a part of the second part is bent.
